(19) United States
(12) Patent Application Publication
(10) Pub. No.: US 2010/0307640 A1
(43) Pub. Date: Dec. 9, 2010

(54) CUTTING EDGE AND CUTTING TOOL

(76) Inventors: La Verne R. Durfee, Harmony, NC (US); David P. Engvall, Stanley, NC (US); Anderson Ednei Nunes, Carlos Barbosa (BR); Paulo Roque Bassotto, Carlos Barbosa (BR)

Correspondence Address: MOORE & VAN ALLEN PLLC, P.O. BOX 13706, Research Triangle Park, NC, 27709, US

(21) Appl. No.: 12/477,605

(22) Filed: Jun. 3, 2009

(51) Int. Cl. B27C 9/00; B23P 17/00; B26B 13/00; B25B 7/02

(52) U.S. Cl. 144/48.5; 29/592; 30/194; 81/418

(57) ABSTRACT

A wood boring drill bit or cutting pliers is disclosed comprising a cutting head made of a first material. A pocket is formed in the cutting head and a filler material is welded in the pocket. A cutting edge is formed on the filler material. The method of making the tool comprises forming a cutting head of a first material having a pocket. A filler material is welded into the pocket. A cutting edge is formed on the filler material such as by grinding or machining.

### BACKGROUND

A variety of types of wood boring bits are known. One type of wood boring bit is a wood auger. Wood augers typically have a single flute that terminates in a cutting edge. A feed tip such as a screw or a cutting tip may also be provided. Another type of wood boring bit is the spade bit. A spade bit typically includes a shank having a relatively flat, wide cutting head. A cutting edge extends from the center of the bit towards each edge of the cutting head. A feed tip such as a screw or a cutting tip may also be provided between the cutting edges. Another type of wood boring bit is the twist bit. The twist bit typically includes a plurality of flutes that define one or more cutting edges at the tip of the bit. Yet another type of wood boring bit is a self feed bit. The self feed bit typically includes a shank that supports a cutting head having an annular cutting edge. A screw tip is provided for feeding the cutting member into and through the wood. A cutting member having a cutting edge is disposed between the annular cutting edge and the tip.

Also known are cutting pliers having a first jaw and handle pivotably connected to a second jaw and handle. The jaws are formed with cutting edges such that the pliers can be used for cutting.

An improved wood boring bit and cutting pliers tool is desired.

### SUMMARY

A wood boring drill bit and cutting pliers are disclosed comprising a cutting head made of a first material. A pocket is formed in the cutting head and filler material is welded in the pocket. A cutting edge is formed on the filler material. The method of making the drill bit comprises forming a cutting head of a first material having a pocket. A filler material is welded into the pocket. A cutting edge is formed on the filler material such as by grinding or machining.

### BRIEF DESCRIPTION OF THE DRAWINGS

FIG. 1 is a plan view of a first embodiment of a bit according to the invention.

FIG. 2 is a detailed plan view showing the cutting edge of the bit of FIG. 1.

FIG. 3 is a section view taken along line 3-3 of FIG. 2.

FIG. 4 is a plan view of a second embodiment of a bit according to the invention.

FIG. 5 is a detailed plan view showing the cutting edge of the bit of FIG. 4.

FIG. 6 is a section view taken along line 6-6 of FIG. 5.

FIG. 7 is a plan view of a third embodiment of a bit according to the invention.

FIG. 8 is a detailed plan view showing the cutting edge of the bit of FIG. 7.

FIG. 9 is a section view taken along line 9-9 of FIG. 8.

FIG. 10 is a plan view of a fourth embodiment of a bit according to the invention.

FIG. 11 is a top view of the bit of FIG. 10.

FIG. 12 is a detailed plan view showing the cutting edge of the bit of FIG. 10.

FIG. 13 is a block diagram illustrating the method of manufacturing the bit of the invention.

FIG. 14 is a perspective view of an embodiment of a cutting pliers according to the invention.

FIGS. 15 through 17 illustrate the process steps for making the pliers of FIG. 14.

### DETAILED DESCRIPTION OF EMBODIMENTS OF THE INVENTION

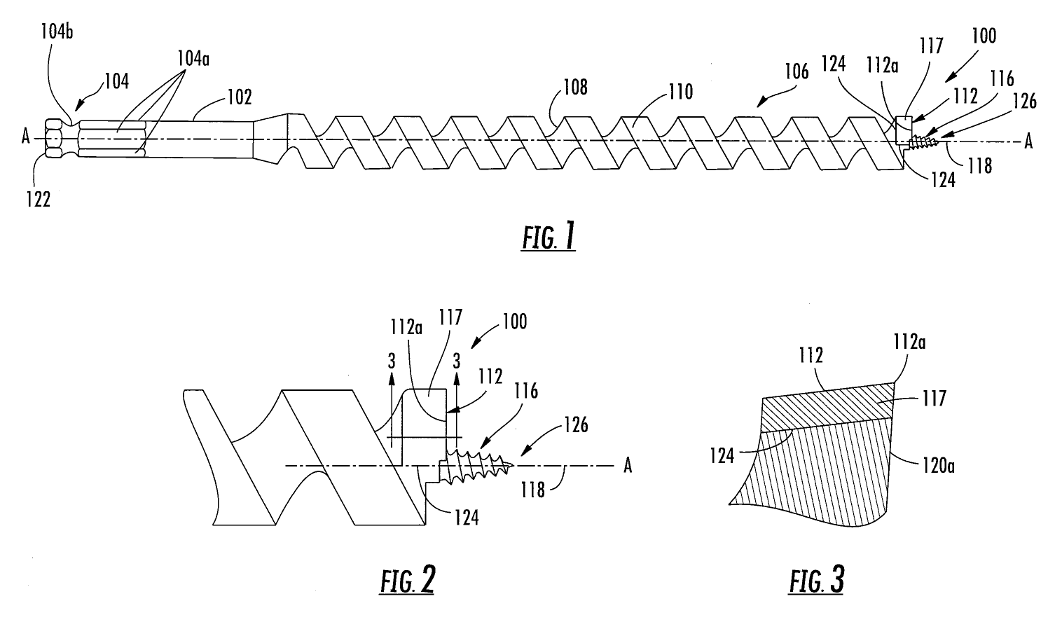

An embodiment of a drill bit is shown in FIGS. 1 through 3 comprising a single flute wood auger 100. Wood auger 100 comprises a shank 102 having a quick coupling 104 disposed at a first end thereof. The quick connect coupling 104 may comprise a plurality flat faces 104a and a recess 104b that may be releasably engaged by the quick connect coupler of the rotary tool such as the chuck of a drill or power driver. Other configurations of shank 2 may also be used for coupling the drill bit to a rotary drive tool.

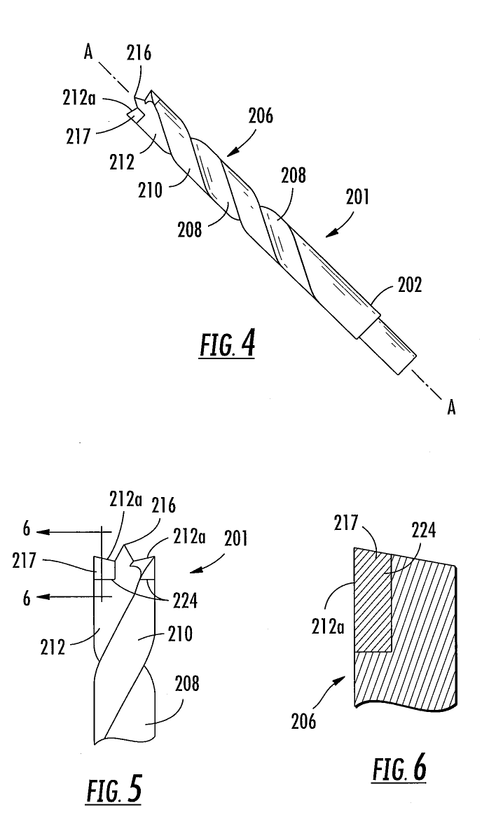

A cutting head 106 is formed on the opposite end of shank 102 from quick connect coupling 104. The cutting head 106 is intended to cut wood and may include a single flute 108 defining a rib 110. Rib 110 has a cutting face 112 formed at the distal end thereof. The cutting face 112 typically extends from the side edge of rib 110 to a centering or pilot point 116 located along the longitudinal axis A-A of the auger. In the illustrated embodiment the centering point 116 is a lead screw 118 having threads for centering the auger and feeding the auger through the wood. The lead screw 118 may be replaced by a lead point as shown in FIG. 4. The lead screw may also be made detachable. Cutting face 112 is formed with a bevel angle to create a sharp cutting edge 112a for cutting the material as the auger rotates.

The cutting edge 112a is formed as filler material 117 made of a hard material that is harder than the material of the remainder of the auger. Except for the hard insert 117 the auger 100 may be formed of a first material such as carbon steel. A pocket 124 is formed in the cutting head 106 adjacent the location of the cutting edge 112a for receiving the high strength filler material 117 (block 1301). The filler material 117 is formed by using an alloyed bead of material such as Chrome Vanadium Alloy that is welded to the cutting head 106 in the pocket 124 using a TIG, MIG, ARC, STICK or Gas welding process (block 1302). Materials other than Chrome Vanadium Alloy may also be used. In TIG (Tungsten Inert Gas) welding a tungsten electrode heats the cutting head in the area that forms pocket 124 in a protective cloud of inert gas such as argon. This process creates a relatively thin layer of weld with low core modification of mechanical and metallurgical properties. MIG or wire feed, and ARC, STICK or gas welding may also be used. The welded bead of material that forms filler material 117 is then sharpened in a grinding process to create the hard cutting edge 112a (block 1303). The filler material 117 is approximately 1 to 4 mm in thickness.

The cutting edge 112a formed on filler material 117 is harder and stronger than the material making up the remainder of the drill bit 100. While weld line 124 is shown in the Figures to illustrate the weld between the cutting head 106 and the filler material 117, the transition between these portions is smooth, uniform and uninterrupted such that the cutting head transitions smoothly into the insert.

In tests a wood auger manufactured as described above was significantly more durable than a standard wood auger. A standard wood auger is able to cut between 10 and 15 nails embedded in a wood material before the drill bit is unusable. A wood auger manufactured as described above was able to cut between 60 and 80 nails before it became unusable. Unusable as used herein means the inability for the screw to pull the wood auger through common building materials such as a pine 2×4.

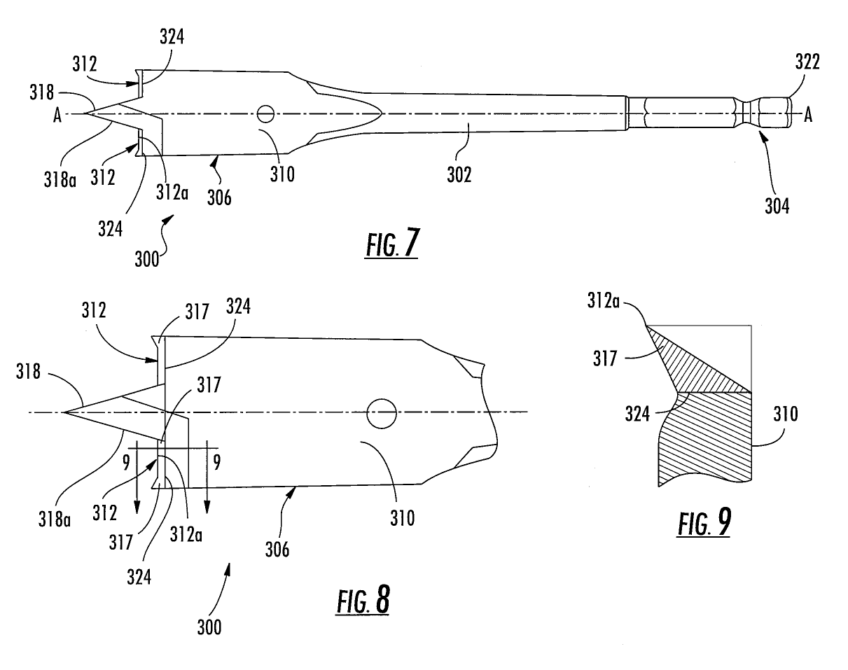

Referring to FIGS. 4 through 6 another embodiment of a drill bit is shown generally at 201 and comprises a shank 202. A cutting head 206 is formed on one end of shank 202. The cutting head 206 is intended to cut wood and may include a plurality of flutes 208 defining a plurality of ribs 210 therebetween. In the illustrated embodiment two flutes and ribs are shown although the cutting head may have a different number flutes and ribs and a variety of designs. Each rib 210 has a cutting face 212 formed at the distal end thereof. The cutting face typically extends from the side edges of ribs 210 to a centering or pilot point 216 located along the longitudinal axis A-A of the drill bit. In the illustrated embodiment the centering point 216 is a lead point for centering the bit and feeding the bit through the wood. The lead point 216 may be replaced by a lead screw such as shown in the embodiment of FIG. 1. Each cutting face 212 is formed with a bevel angle to create a sharp cutting edge 212a on each of the ribs for cutting the material as the drill bit rotates.

The cutting edge 212a is formed as filler material 217 made of a hard material that is harder than the material of the remainder of the bit. Except for the hard filler material 217 the bit 201 may be formed of a first material such as carbon steel. A pocket 224 is formed in the cutting head 206 adjacent the location of the cutting edge 212a for receiving the high strength filler material 217. The filler material 217 is formed by using an alloyed bead of material such as, but not limited to, Chrome Vanadium Alloy that is welded to the cutting head 206 in the pocket 224 using a TIG, MIG, ARC, Stick or gas welding process. In TIG (Tungsten Inert Gas) welding a tungsten electrode heats the cutting head in the area that forms pocket 224 in a protective cloud of inert gas such as argon. This process creates a relatively thin layer of weld with low core modification of mechanical and metallurgical properties. MIG or wire feed welding may also be used. The welded bead of material that forms filler material 217 is then sharpened in a grinding process to create the hard cutting edge 212a. The filler material 217 is approximately 1 to 4 mm in thickness.

The cutting edge is harder and/or stronger than the material making up the remainder of the drill bit. While weld line 224 is shown in FIG. 3 to illustrate the weld between the filler material 217 and the cutting head 206, the transition between these portions is smooth, uniform and uninterrupted such that the cutting head transitions smoothly into the insert.

A third embodiment of a drill bit is shown in FIGS. 7 through 9 comprising a spade bit 300. Spade bit 300 comprises a shank 302 having a quick coupling 304 disposed at a first end thereof, as previously described, that may be releasably engaged by the quick connect coupler of the rotary tool.

A cutting head 306 is formed on the opposite end of shank 302 from quick connect coupling 304. The cutting head 306 is intended to cut wood and may include a relatively wide flat blade 310. Blade 310 has a pair of cutting faces 312 formed at the distal end thereof. The cutting faces 312 typically extend from the side edges of cutting head 306 to a centering or pilot point 318 located along the longitudinal axis A-A of the drill bit. In the illustrated embodiment the centering point 318 has substantially straight cutting edges 318a formed on opposite sides of lead point 318 for boring a pilot hole in the material being drilled to center and guide the bit. The lead point 318 may be replaced by a screw point. Cutting faces 312 are formed with a bevel angles to create sharp cutting edges 312a for cutting the material as the bit rotates.

Each cutting edge 312a is formed as a filler material 317 made of a hard material that is harder than the material of the remainder of the bit. Except for the hard filler material 317 the bit 300 may be formed of a first material such as carbon steel. A pocket 324 is formed in the cutting head 306 adjacent the location of the cutting edge 312a for receiving the high strength filler material 317. The insert 317 is formed by using an alloyed bead of material such as, but not limited to, Chrome Vanadium Alloy that is welded to the cutting head 306 in the pocket 324 using a TIG, MIG, ARC, Stick or gas welding process. In TIG (Tungsten Inert Gas) welding a tungsten electrode heats the cutting head in the area that forms pocket 324 in a protective cloud of inert gas such as argon. This process creates a relatively thin layer of weld with low core modification of mechanical and metallurgical properties. MIG or wire feed welding may also be used. The welded bead of material that forms filler material 317 is then sharpened in a grinding process to create the hard cutting edge 312a. The insert 317 is approximately 1 to 4 mm in thickness.

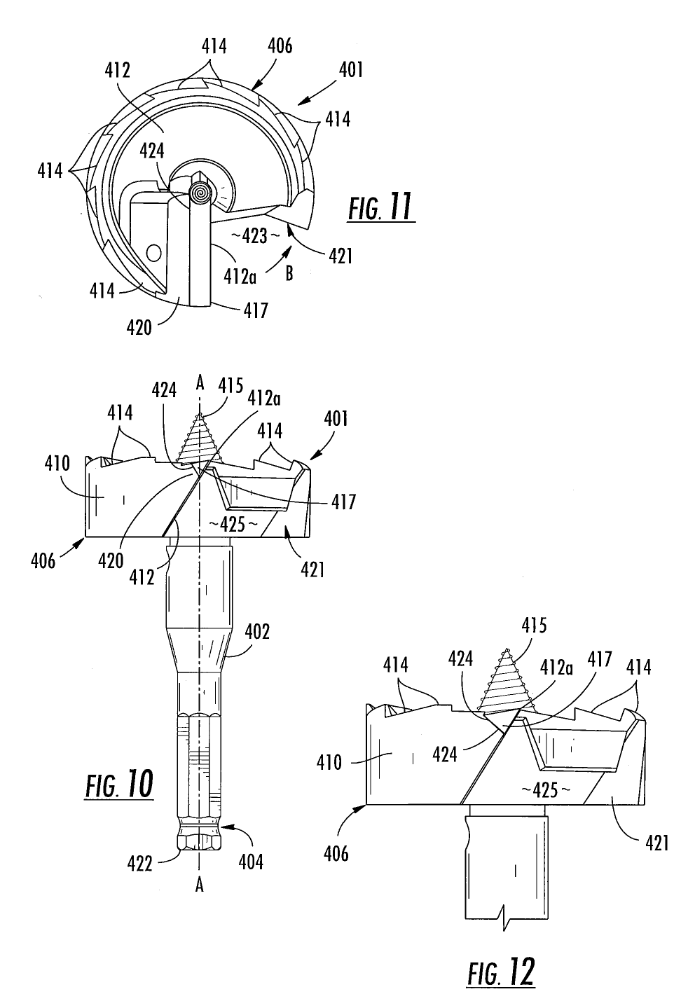

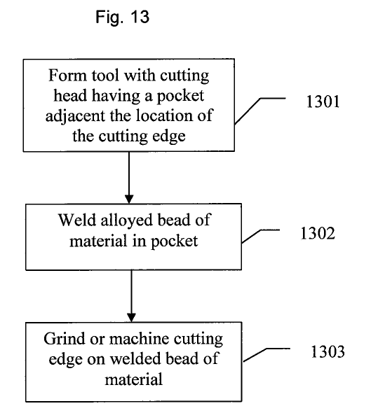

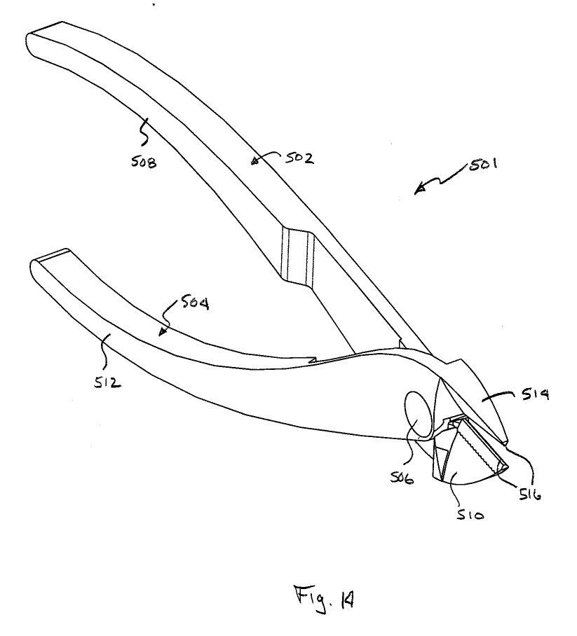

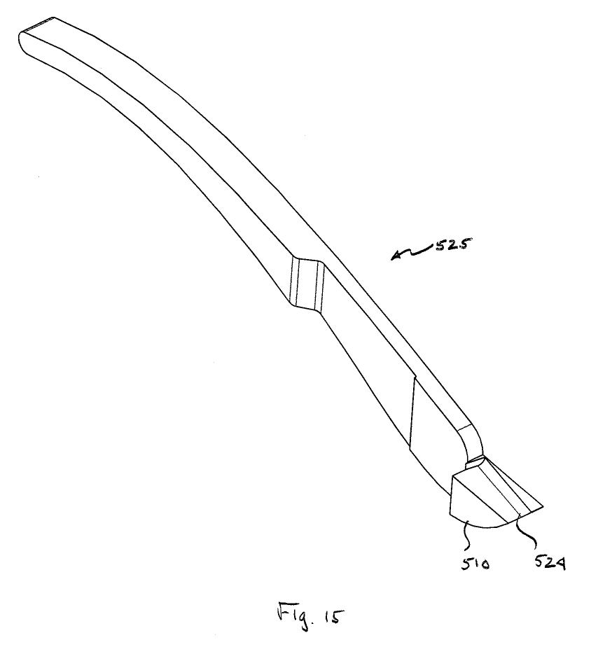

Referring to FIGS. 10 through 12 a fourth embodiment of a drill bit is shown generally at 401 and comprises a shank 402 having a quick coupling 404 disposed at a first end thereof as previously described. A cylindrical, cup shaped cutting head 406 is formed on the opposite end of shank 402 from quick connect coupling 404. The cutting head 406 comprises an annular flange 410 connected to shank 402 by a round base 412. Formed on the distal edge of the flange 410 are a plurality of teeth 414 that create an annular cutting edge. When the drill bit is rotated about the rotational axis A-A the teeth 414 score the material being cut to create a clean cut around the periphery of the hole being drilled. A screw tip 415 is formed along the rotational axis A-A of the bit that engages the material being cut to feed the bit through the material. The screw tip 415 may be made removable from the remainder of the bit.

A cutting blade or lifter 420 is secured to the cutting head 406. When the drill bit is rotated at high speed in the direction of arrow B, the cutting blade 420 lifts the material from the interior of the hole being drilled. A trough 421 is formed in wall 410 and base 412 in front of the cutting blade 420 to create an open area for the wood chips to be ejected from the drill bit during a drilling operation. Trough 421 is created by a gap 423 formed in the base 412 and a coextensive gap 425 formed in flange 410. Cutting face 412 is formed with a bevel angles to create sharp cutting edge 412a for cutting the material as the bit rotates.

The cutting edge 412a is formed as a filler material 417 made of a hard material that is harder than the material of the remainder of the bit. Except for the hard filler material 417 the bit 401 may be formed of a first material such as carbon steel. A pocket 424 is formed in the cutting head 406 adjacent the location of the cutting edge 412a for receiving the high strength filler material 417. The insert 417 is formed by using an alloyed bead of material such as, but not limited to, Chrome Vanadium Alloy that is welded to the cutting head 406 in the pocket 424 using a TIG, MIG, ARC, Stick or gas welding process welding process. In TIG (Tungsten Inert Gas) welding a tungsten electrode heats the cutting head in the area that forms pocket 424 in a protective cloud of inert gas such as argon. This process creates a relatively thin layer of weld with low modification of mechanical and metallurgical properties of the first material. MIG or wire feed welding may also be used. The welded bead of material that forms filler material 417 is then sharpened in a grinding process to create the hard cutting edge 412a. The insert 417 is approximately 1 to 4 mm in thickness.

Drill bits constructed as described above may be used in any wood boring application but are particularly suitable in applications where the drill bit may contact obstructions in the wood such as buried nails, screws, other fasteners or other foreign bodies including metal objects.

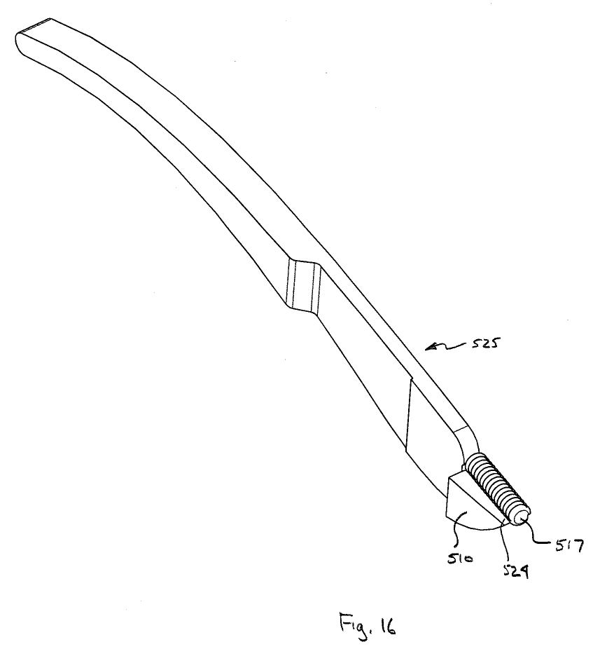

Referring to FIGS. 14 through 17 an embodiment of a cutting pliers in accordance with the invention is shown. The cutting pliers 501 comprises a first pivoting member 502 joined to a second pivoting member 504 at pivot 506. The member 502 has a handle 508 formed at one end and a cutting head or jaw 510 formed at the other end. The member 504 has a handle 512 formed at one end and a cutting head or jaw 514 formed at the other end. Each cutting head 510, 514 supports a cutting edge 516 that cooperate to effect a cutting operation when the handles 508, 512 are brought together. The handles and cutting heads are made of a first material such as carbon steel. The cutting edges 516 are formed as filler material 517 made of a hard material that is harder than the material of the remainder of the pliers.

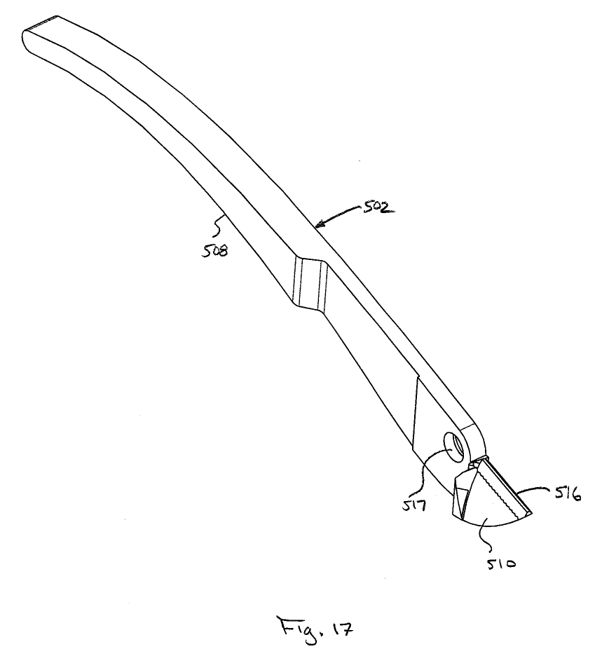

To make the pliers a forged blank of material is formed for each of the members 502 and 504. One of the blanks is shown at 525 in FIG. 15. A pocket or groove 524 is formed in the cutting heads or jaws 510, 514 adjacent the location of the cutting edge 516 for receiving the high strength filler material 517 (block 1301). Referring to FIG. 16, the filler material 517 is formed by using an alloyed bead of material such as, but not limited to, Chrome Vanadium Alloy that is welded to the cutting heads or jaws 510, 516 in the pocket 524 using a TIG, MIG, ARC, Stick or gas welding process welding process (block 1302). This process creates a relatively thin layer of weld with low modification of mechanical and metallurgical properties of the first material. MIG or wire feed welding may also be used. The plier halves are then annealed, coined and machined. A sharp cutting edge is machined out of each filler material 517 to create the finished cutting edges 516 as shown in FIG. 17 (block 1303).

The pliers are assembled by inserting the pivot 506 through apertures 517 in each of members 502 and 504. The assembled tool is through hardened with a quench and temper process. The pliers is then adjusted and straightened. The cutting edges 516 are induction hardened to produce the final material properties. The cutting edges are then adjusted to complete the tool.

While embodiments of the invention are disclosed herein, various changes and modifications can be made without departing from the spirit and scope of the invention. One of ordinary skill in the art will recognize that the invention has other applications in other environments. Many embodiments are possible. The following claims are in no way intended to limit the scope of the invention to the specific embodiments described above.

1. A wood boring drill bit comprising:
a cutting head made of a first material;
a pocket formed in the cutting head; and
a filler material welded in the pocket, said filler material forming at least one cutting edge.

2. The wood boring bit of claim 1 wherein said cutting head is an auger.

3. The wood boring bit of claim 2 wherein said auger has a single cutting edge.

4. The wood boring bit of claim 1 wherein said cutting head is a spade bit.

5. The wood boring bit of claim 4 wherein said spade bit has two cutting edges

6. The wood boring bit of claim 1 wherein said cutting head is a self-feed bit.

7. The wood boring bit of claim 1 wherein said cutting head is a twist bit.

8. The wood boring bit of claim 7 wherein said cutting head has a plurality of cutting edges.

9. The wood boring bit of claim 1 wherein said filler material is located only adjacent the cutting edge.

10. The wood boring bit of claim 1 wherein said filler material is chrome vanadium alloy.

11. A wood boring bit obtained by the process comprising:
forming a cutting head of a first material having a pocket;
welding a filler material into said pocket;
forming a cutting edge on said filler material.

12. The wood boring bit of claim 11 wherein said first material is carbon steel

13. The wood boring bit of claim 11 wherein said welding comprises TIG filler.

14. The wood boring bit of claim 11 wherein said cutting edge is formed by grinding.

15. The wood boring bit of claim 14 wherein said grinding is performed after the filler material is welded in the pocket.

16. The wood boring bit of claim 11 wherein said filler material is high strength alloy.

17. A method of making a tool comprising:
forming a cutting head of a first material having a pocket;
welding a filler material into said pocket;
forming a cutting edge on said filler material.

18. The method of claim 17 wherein the welding comprises TIG, MIG, ARC, Stick or gas welding.

19. The method of claim 17 wherein the step of forming comprises grinding said cutting edge.

20. The method of claim 17 wherein the filler material is high strength alloy.

21. A cutting pliers comprising:
a first pivoting member joined to a second pivoting member at a pivot where the first pivoting member has a first handle formed at one end and a first cutting jaw formed at the other end and the second pivoting member has a second handle formed at one end and a second cutting jaw formed at the other end;
the first cutting jaw having a first pocket and the second cutting jaw having a second pocket;
a filler material welded in the first pocket and in the second pocket, said filler material forming a first cutting edge in the first pocket and a second cutting edge in the second pocket.

22. The cutting pliers of claim 21 wherein said first pivoting member and said second pivoting member are formed of a first material different than the filler material.

23. The cutting pliers of claim 21 wherein said weld comprises a TIG, MIG, ARC, Stick or gas weld.

24. The cutting pliers of claim 21 wherein said cutting edge is machined.

25. The cutting pliers of claim 21 wherein said filler material is chrome vanadium alloy.
